(19) United States
(12) Patent Application Publication
(10) Pub. No.: US 2003/0208613 A1
(43) Pub. Date: Nov. 6, 2003

(54) Managing user interaction for live multimedia broadcast

(75) Inventors: Julien Signes, San Francisco, CA (US); Eric Deniau, La Baussaine (FR); Renaud Cazoulat, Rennes (FR); Yuval Fisher, San Marino, CA (US)

Correspondence Address: SWERNOFSKY LAW GROUP PC, P.O. BOX 390013, MOUNTAIN VIEW, CA, 94039-0013, US

(73) Assignee: Envivio.com, Inc., South San Francisco, CA

(21) Appl. No.: 10/137,719

(22) Filed: May 2, 2002

(51) Int. Cl. G06F 15/16

(52) U.S. Cl. 709/231

(57) ABSTRACT

A technique wherein a data stream received by a viewer is responsive to input from other viewers. The data stream is sent from a server to a set of users who generate various responses to the media stream. The responses are analyzed and the analysis or other appropriate response is back to the users. In this way, the information displayed by a user is modified by how other users interact with the media stream. Additionally, the response of a particular user to a data stream may result in personalized information being sent to that user in real time. Various configurations are used to multicast or unicast a program to users and multicast or unicast additional information that is responsive to input from those users.

### BACKGROUND OF THE INVENTION

1. Field of the Invention

The invention relates to evaluating and responding to input from a user regarding an interactive media stream.

2. Related Art

A first form of interactive multimedia broadcast includes streaming media. Streaming media involves the transfer of data from a server to one or more clients in a steady and continuous stream. Using this technique, events can be broadcast or multicast (“netcast”), to a relatively large audience. Elements such as HTML objects, Flash animations, audio/visual streams, Java scripts or similar objects are included in the media stream to create an interactive environment. Such displays are particularly engaging because the user can generate responses to interactive elements or browse embedded links to other media such as may be available in the media stream.

A drawback to this technique is that the type and level of interactivity is limited by the heterogeneity and multiplicity of elements included in the stream. In many instances, interaction with certain stream elements is not possible (in particular, the audio/visual elements). Obtaining user feedback regarding a particular scene in a data stream that is composed of different elements can be exceedingly complex. In many instances, the user feedback is not particularly meaningful because the response is to a particular element rather than to the particular scene. Similarly, media elements received by a particular user cannot reflect input from other users.

A second form of interactive multimedia involves teleconferencing using a network connection and a computer. Depending upon the implementation, an electronic whiteboard is presented on a computer screen or other presentation element to individuals at one or more locations. These individuals use the whiteboard to interactively share information among themselves. Variations of this technique are frequently used in business and education. Individual members provide input that is shared by all other members, who can, in turn, formulate a response that is shared by all.

A drawback to this technique is that it is not possible to tailor information for a single member of the group and send the information to that single member during the regular course of the communication. This is problematic in teaching applications in which a teacher wishes to provide private, personalized comments to a student's work during the course of a lesson. It is also problematic when an attendee of a video-conference wishes to receive information about the responses of other group members, but does not wish to receive the responses from other viewers.

### SUMMARY OF THE INVENTION

In a first aspect of the invention, a user display responsive to input from one or more users is generated from a single, integrated audio-visual, mixed-media rendering based on MPEG4 technology. Users watch a media stream and generate responses. These responses are sent to a server where they are analyzed and new audio-visual elements relating to that analysis are generated. These new elements are sent from the server to each user. In this way, the media displayed to a user is responsive to the particular interactions that other users have with the media stream. This management of user interaction is very different from whiteboarding and other video conferencing techniques. Firstly, although whiteboarding and video conferencing involve accessing a network, the content of the conference is not determined at a server. Secondly, the display received by parties to a video conference or a whiteboard meeting includes only information provided directly by the participants; it does not include material responsive to that information.

In a second aspect of the invention, the response of a user to an interactive element may result in personalized media being sent to that user in real time. Unlike interactive elements which call up a fixed number of possible displays depending upon what is embedded in the data stream, this personalized media is not limited to a fixed II number of displays or to a particular interaction with an element embedded in the data stream. In one embodiment, development of such personalized media for a user requires computation on the server side. In another embodiment, developing the personalized media requires input from an operator located on the server side.

Various embodiments include educational programs in which an instructor delivers special material to one or more students who require individualized work (for example, a special problem set for advanced math students), gaming shows in which a user receives aggregated information relating to other viewers' scores, entertainment shows in which a live performer may continue or suspend a performance in response to feedback from viewers, and other similar applications.

### BRIEF DESCRIPTION OF THE DRAWINGS

FIG. 1 is a block diagram showing a system for managing user interaction in a live multimedia broadcast.

FIG. 2 is a flow diagram showing a method for managing user interaction in a live multimedia broadcast.

FIG. 3 is a flow diagram of a first example of a method for managing user interaction in a live multimedia broadcast.

FIG. 4 is a flow diagram of a second example of a method for managing user interaction in a live multimedia broadcast.

### DETAILED DESCRIPTION OF THE PREFERRED EMBODIMENT

In the description herein, a preferred embodiment of the invention is described, including preferred process steps, materials and structures. Those skilled in the art would realize, after perusal of this application, that embodiments of the invention might be implemented using a variety of other techniques not specifically described, without undue experimentation or further invention, and that such other techniques would be within the scope and spirit of the invention.

Lexicography

The following terms relate or refer to aspect of the invention or it's embodiments. The general meaning of each of these terms is intended to be illustrative and in no way limiting.

BIFS—as used herein, BIFS (binary format for scenes) refers to a component of the MPEG-4 toolkit. It includes a data structure for defining and manipulating an MPEG-4 multimedia scene, as well as its compressed format.

terminal—as used herein, the term “terminal” includes a client device that is used to receive and display one or more media streams. This may include a computing device coupled to a network or a television with a set-top box coupled to a network.

client device and server device—as used herein, the phrase “client device” includes any device taking on the role of a client in a client-server relationship (such as an HTTP web client). There is no particular requirement that any client devices must be individual physical devices; they can each be a single device, a set of cooperating devices, a portion of a device, or some combination thereof. As used herein, the phrase “server device” includes any device taking on the role of a server in a client-server relationship (such as an HTTP web server). There is no particular requirement that server devices must be individual physical devices; they can each be a single device, a set of cooperating devices, a portion of a device, or some combination thereof. As used herein, the phrases, “client device” and “server device” refer to a relationship between two devices, particularly to their relationship as client and server, not necessarily to any particular physical devices.

streaming media—as used herein, the term “streaming media” includes at least one sequence of data chunks (including media data) that is capable of being sent over a network and presented to a recipient. For example, streaming media can include animation, audio information, motion picture or video information, still pictures in sequence, or other time-varying data. In a more general sense, streaming media can include non-visual data such as stock market information or telemetry.

System Elements

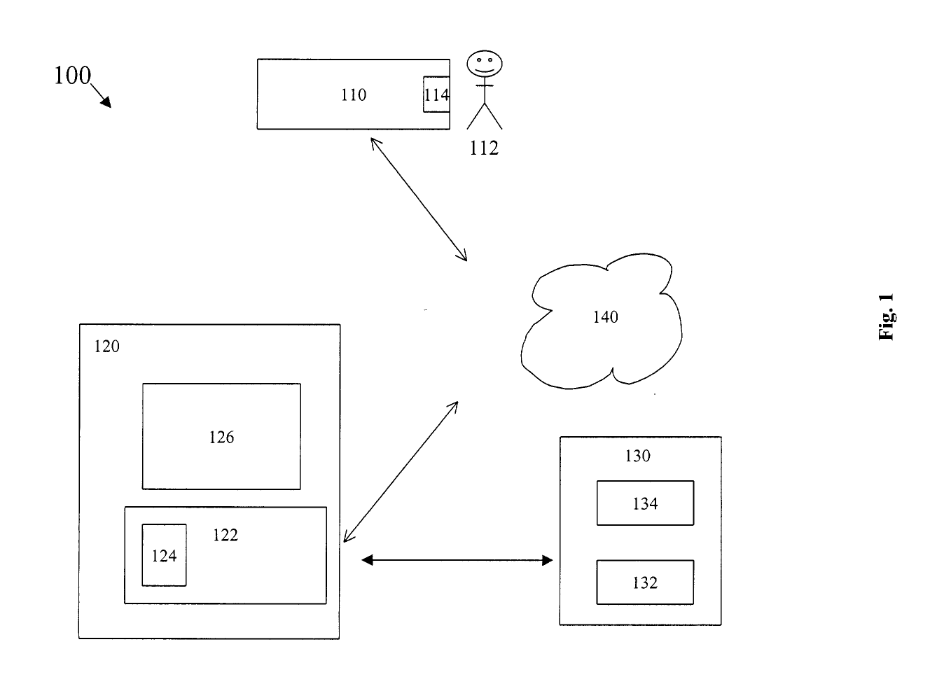

FIG. 1 is a block diagram showing a system for managing user interaction in a live multimedia broadcast.

A system 100 includes at least one terminal 110, a streaming server 120, an authoring workstation 130 and a communications link 140.

Each terminal 110 is under the control of a user 112. The terminal 110 preferably includes a buffer for storing media and sufficient circuitry or software for presenting the media stream to a user 112. The terminal 110 receives the media stream from a streaming server 120, buffers and decodes that stream, and presents it to the user 1 12. In one embodiment, the data stream includes an MPEG-4 presentation.

Each terminal 110 further includes a server controller 114 that interacts with the streaming server 120. The server controller 114 receives commands from the user 112, recognizes the syntax of those commands and sends them to the streaming server 120. These commands may include the user's responses to the media stream.

Various embodiments of the terminal 110 include a computer and monitor, or a television and set-top box, among others.

The streaming server 120 preferably includes a server 122, a server plug-in manager 124 and an application plug-in 126.

The server 122 preferably includes a processor, a memory and sufficient server software so as to transmit the media stream and additional information to the terminals 110, either in multicast or unicast form. Multicasting involves sending the media stream or additional information responsive to user input that is targeted to more than one user 112. Unicasting involves sending a primary media stream or additional information responsive to user input that is targeted to a single user 112. Different configurations of the system 100 include the following combinations of multicasting and unicasting:

A scene is multicast to a group of users and additional information is multicast to each user in the group.

A scene is multicast to a group of users and different information is unicast to each user of the group.

A scene is unicast to each user in a group and different information is unicast to each user in the group.

A scene is unicast to each user in a group and different information is multicast to each user in the group.

The server plug-in manager 124 manages a return path connection between the streaming server 120 and the terminals 110. This return path connection includes information sent from a user 112 in response to a data stream. The server plug-in manager 124 receives this information from a user 112 and sends it to a particular application plug-in 126.

In some embodiments, the server plug-in manager 124 is situated in a location that is logically or physically remote from the streaming server 120. In other embodiments, the server plug-in manager 124 is situated more proximately to the streaming server 120.

The set of application plug-ins 126 includes one or more application-specific plug-ins. Each application plug-in 126 is associated with a particular application used in the generation of interactive responses. The application plug-ins 126 receive user input (for example, commands and responses to the media stream) from the server plug-in manager 124, interpret the input and process it. The type of information processing that takes place is responsive to the nature of the input. For example, the application plug-in 126 may (1) store the input in a database, (2) aggregate the input received from a large number of viewers and perform a statistical analysis of the aggregated responses (for example, determine what percentage of viewers got an answer wrong in a game show) or (3) determine that further responses to the user input need to be generated at the authoring workstation 130.

After processing the input, the application plug-in 126 generates a response that is sent to the authoring workstation 130. The response preferably includes a high-level text-based description using xml (extensible Markup Language), VRML (Virtual Reality Markup Language) or a similar element. This text-based description describes a scene description update that is responsive to the user input. The authoring workstation 130 sends the encoded media to the server 122, which streams it to the user 112. The authoring workstation 130 includes a “live authoring” module 132 (as further described below) and an off-line authoring workstation 134 (as further described below). Both the live authoring module 132 and the off-line authoring workstation 134 include a processor, memory and sufficient software to interpret the scene descriptions and generate MPEG-4 encoded media such as BIFS (binary format for scenes) and OD (object descriptor) data. BIFS is the compressed format used for compressing MPEG-4 scene descriptions. An OD is a MPEG-4 structure similar to a URL. These BIFS and OD forms include the information that is streamed to the user 112 in response to user input.

The live authoring module 132 includes a tool for generating content. In one embodiment, content is generated automatically by software (for example, the software may generate a set of math problems that involve a specific type of calculation). In other embodiments, a human operator works with the software to generate the content (for example, manipulating software tools). In still other embodiments, the live authoring module 132 is used by a performance artist who generates content. The software, human operator and performance artist all generate content in real time.

The off-line authoring workstation 134 includes a library of previously prepared media that can be used by the live authoring module 132 to generate content in response to user input. Examples of this pre-prepared media include templates of background layouts and other stylistic materials, as well as specific problem sets that a teacher might send to students who need extra practice in a particular area. Such prepared media may be sent directly to the user 112 without modification or may be modified in real time at the live authoring module 132.

In a preferred embodiment, the authoring workstation 130 is logically coupled to the streaming server 120. Materials that are identified or generated at the authoring workstation 130 are sent to the terminal 110 by the streaming server 120.

The communication link 140 can include a computer network, such as an Internet, intranet, extranet or a virtual private network. In other embodiments, the communication link 140 can include a direct communication line, a switched network such as a telephone network, a wireless network, a form of packet transmission or some combination thereof. All variations of communication links noted herein are also known in the art of computer communication. In a preferred embodiment, the terminal 110, the streaming server 120 and the authoring workstation 130 are coupled by the communication link 140.

Method of Use

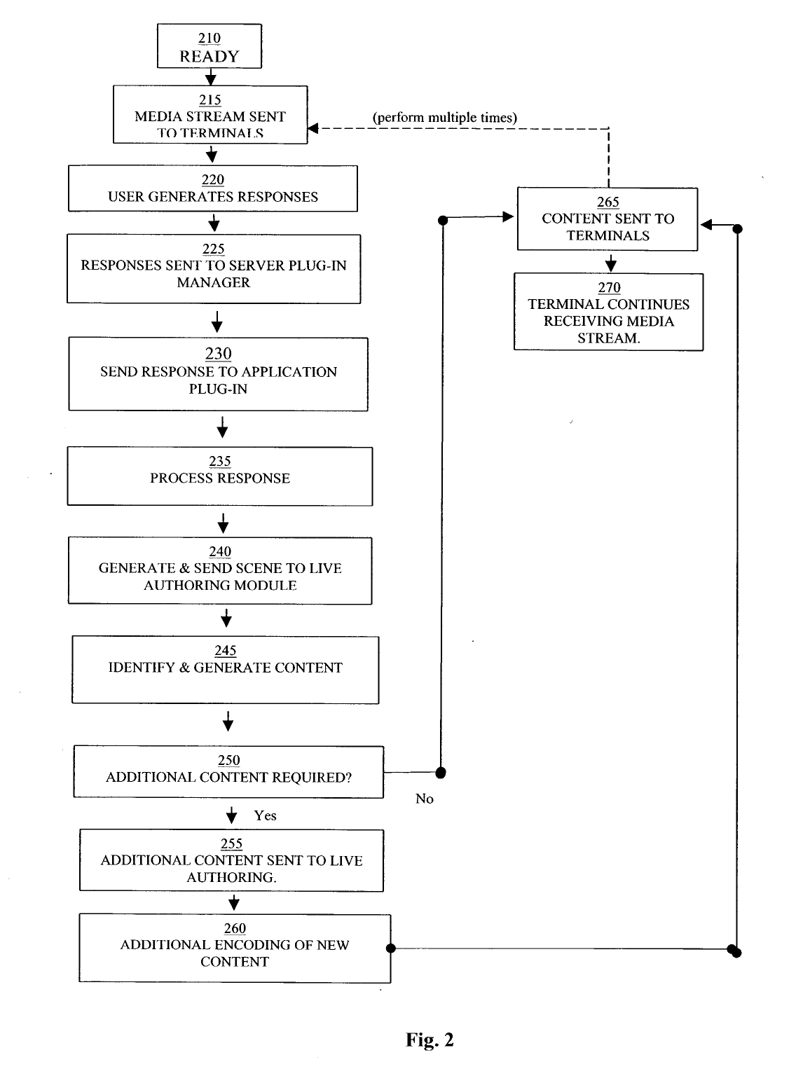

FIG. 2 is a flow diagram showing a method for managing user interaction in a live multimedia broadcast.

A method 200 includes a set of flow points and a set of steps. In one embodiment, the system 100 performs the method 200, although the method 200 can be performed by other systems. Although the method 200 is described serially, the steps of the method 200 can be performed by separate elements in conjunction or in parallel, whether asynchronously, in a pipelined manner, or otherwise. There is no particular requirement that the method 200 be performed in the same order in which this description lists the steps, except where so indicated.

At a flow point 210, the system 100 is ready to begin performing a method 200.

In a step 215, the server 122 sends a media stream to at least one terminal 110. This media stream may be multicast to a number of terminals 110 or unicast to each terminal 110. The media stream includes any number of media types, including audio, video, animation and others such as may be included in an MPEG-4 presentation. The content of the media stream can include portions where feedback from a user 112 is solicited. For example, a teaching program may require that students answer questions, a game show may require “moves” on the part of contestants or an entertainment show may ask if the users desire that a performer continue a performance.

In a step 220, the media stream is received by the server controller 114 and presented to the user 112. The user 112 generates responses to the media stream by interacting with the media stream using a pointing device such as a mouse, joystick, infrared remote-control keyboard or by using voice recognition software.

In a step 225, the user's responses are sent from the server controller 114 to the server plug-in manager 124.

In a step 230, the server plug-in manager 124 determines which application plug-in 126 is associated with the user response and sends the user response to the appropriate application plug-in 126.

In a step 235, the application plug-in 126 receives the user response from the server plug-in manager 124 and processes the response. In one embodiment, this step includes receiving inputs from many different users to the same media stream. Processing those inputs may involve one or more of the following: (1) aggregating those responses and performing a statistical analysis of the responses, such as determining what percentage of an audience selected a particular answer, (2) reviewing answers from students to determine whether a majority of students understand the content included in a media stream, (3) determining whether the majority of viewers wish to continue watching a particular performing, and (4) other similar calculations.

In a step 240, the application plug-in 126 generates a scene update and sends that file to the live authoring module 132. A scene update preferably includes information that is necessary for the live authoring module 132 to prepare a response to the user.

In a step 245, the live authoring module 132 identifies content that is responsive to the user 112 and encodes that content. This content can include visual backgrounds, audio backgrounds and other stylistic elements. In one embodiment, live authoring is an automatic process. Selection of appropriate stylistic elements and encoding of those elements is performed by a set of computer instructions without input from an operator. In another embodiment, live authoring is an operator assisted process. The operator provides some input in selecting and manipulating different stylistic elements. In yet another embodiment, live authoring requires a human content creator who generates content in real time on behalf of one or more users 112.

In a step 250, the live authoring module 132 determines if additional content is required. If no further content is required, the method proceeds at step 260. If additional content is needed, the method proceeds at step 255.

At a step 255, the live authoring module 132 obtains the required content from the off-line workstation 134. This content may include previously prepared materials such as might be used by an instructor or media templates with various layouts, backgrounds, and other stylistic conventions such as may be useful in presenting material to a user 112. The live authoring module 132 uses this content in conjunction with other content determined at the live authoring module 132 as described in step 245 to generate appropriate material that is responsive to one or more users 112.

At a step 260, the live authoring module 132 determines if additional encoding is necessary, encodes the content, and sends the encoded content to the streaming server 120.

In a step 265, the streaming server 120 sends the encoded content to one or more of the terminals 110. Depending upon the nature of the response and the application plug-in request, these responses may be unicast or multicast. For example, if the response involves a display of statistics, the display might be multicast to more than all of the users 112; however, if the response is more individually tailored (for example comments from an instructor), the content might be unicast to that particular user.

In a step 270, the terminal 110 continues receiving the media stream. Steps 215 through 265 may be performed multiple times during the media stream.

Example of an Educational Application

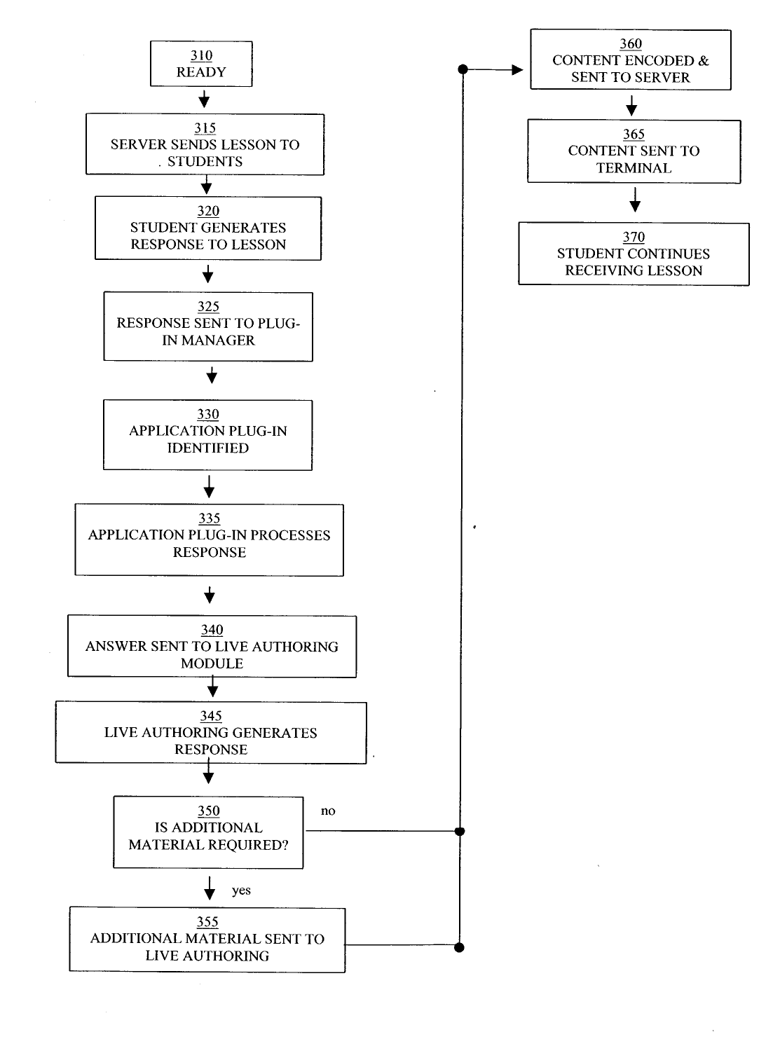

FIG. 3 is a flow diagram of a first example of a method for managing user interaction in a live multimedia broadcast.

A method 300 includes a set of flow points and a set of steps. In one embodiment, the system 100 performs the method 300; in other embodiments the method 300 may be performed by other systems. Although the method 300 is described serially, the steps of the method 300 can be performed by separate elements in conjunction or parallel, whether asynchronously, in a pipelined manner or otherwise. There is no particular requirement that the method 300 be performed in the same order in which this description lists the steps, except where so indicated.

At a flow point 310, the system 100 is ready to begin performing a method 300. In this example, the users 112 are a set of students.

At a step 315, the server 122 sends a media stream to a set of terminals 110, such that each terminal 110 is under the control of a user 112. In this particular example, the media stream includes a lesson prepared by an instructor. The users 112 are students who receive this particular lesson.

In a step 320, the lesson is received by the server controller 114 and presented to a student. The student generates responses to the lesson. These responses may include answers to questions posed to the students, questions about the material, requests for additional help and similar interactions.

In a step 325, the student's responses are sent from the server controller 114 to the server plug-in manager 124.

In a step 330, the server plug-in manager 124 identifies which application is associated with the student's response and sends the student's response to the appropriate application plug-in 126. In this example, the appropriate application plug-in 126 is associated with the particular types of educational and communication software such as may be used in this particular educational program. Different application plug-ins 126 may be used in different educational applications.

In a step 335, the application plug-in 126 receives the student's responses from the server plug-in manager 124 and processes them. Processing may include one or more of the following:

determining whether the student had the correct answer;

determining whether the number of students getting correct answers or wrong answers or some combination of correct or wrong answers exceeds a pre-set threshold;

determining which explanation to provide to a student to the student;

identifying a question that students repeatedly get wrong;

identifying a student whose error rate exceeds a particular threshold

performing a preliminary analysis on the types of questions that are being asked so as to determine whether they merit individual responses or whether the question should be addressed before the entire group of students; and

other types of calculations such as may be useful to either the teacher or student.

In a step 340, the application plug-in 126 generates a scene update corresponding to the answer that will be made to the student and sends a file including the scene update to the live-authoring module 132.

In a step 345, the live authoring module 132 generates the response according to the analysis performed in step 335. In one embodiment, this includes computing a set of materials that are responsive to one or more of the students (for example, entering parameters that describe a particular type of math problem so as to generate more examples). In another embodiment, a content creator (either a human operator or an automatic agent) uses the tools included in the live authoring module 132 to generate answers to questions from the student in real time.

In a step 350, the live authoring module 132 determines if further content is needed. If no further content is needed the method proceeds at step 360. If additional content is needed, the method proceeds at step 355.

In a step 355, the live authoring module 132 obtains additional material from the off-line workstation 134. This material may include one or more of the II following: problem sets (for example, math problems, language exercises or another materials), explanatory materials, templates such as grade or class specific background templates to as to identify the content with a particular grade, class or program, background templates that reflect holiday or seasonal themes such as may appeal to younger students, sound templates (for example, an audio track template that accompanies the beginning of a problem set) and other similar materials. The live authoring module 132 combines this material with other materials identified in step 345 to create an integrated presentation.

In a step 360, the live authoring module 132 encodes the content and sends the encoded content to the streaming server 120.

In a step 365, the streaming server 120 sends the encoded content to one or more terminals 110. This may include unicasting a set of special problems to a student who is experiencing difficulties, unicasting an answer in response to a particular student's question, multicasting a problem set or other materials to the group of students and other similar responses that enhance the educational process.

In a step 370, the students continue receiving the media stream and the regular lesson resumes. Steps 310-365 may be repeated whenever it is necessary to supplement the regular lesson or provide individualized responses.

Example of an Entertainment Application

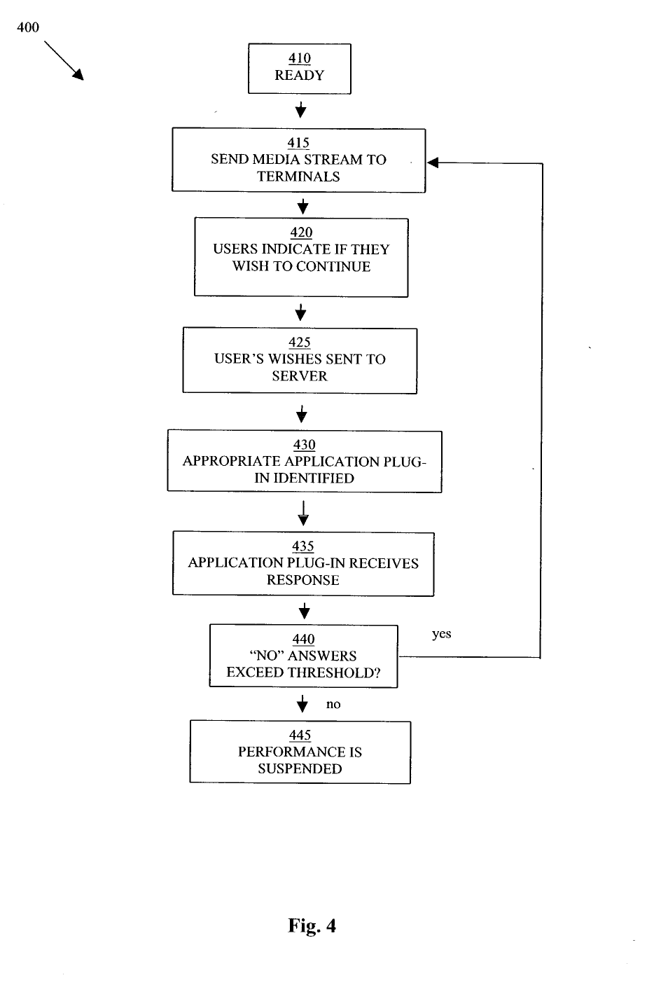

FIG. 4 is a flow diagram of a second example of a method for managing user interaction in a live multimedia broadcast.

A method 400 includes a set of flow points and a set of steps. In one embodiment, the system 100 performs the method 400; in other embodiments, the method 300 may be performed by other systems.. Although the method 400 is described serially, the steps of the method 400 can be performed by separate elements in conjunction or parallel, whether asynchronously, in a pipelined manner or otherwise. There is no particular requirement that the method 400 be performed in the same order in which this description lists the steps, except where so indicated.

At a flow point 410, the system 100 is ready to begin performing a method 400.

At a step 415, the server 122 sends a media stream to at least one terminal 110. This media stream may be multicast to a number of terminals 110 or unicast to each terminal 110. The media stream includes any number of media types including audio, video, animation and other types such as may be included in an MPEG-4 presentation of a performer. In one embodiment, the performer may be a musician, comedian, actor, singer or some other type of entertainer. The content of the media stream includes segments in which the viewers are asked if they wish to continue watching the performer or if they wish to stop the performance.

At a step 420, the media stream is received by the server controller 114 and presented to the user 112. The user 112 watches the media stream until such time as is they are asked if they wish to continue watching that particular performer. The user 112 responds to this query by manipulating a pointing device such as a mouse, joystick, infrared remote control keyboard or by using voice recognition software.

In a step 425, the user's preferences regarding whether they wish to continue watching a particular performer are sent from the server controller 114 to the server plug-in manager 124.

In a step 430, the server plug-in manager 124 determines which application plug-in 126 is associated with the user response and sends the user response to the appropriate application plug-in 126.

In a step 435, the application plug-in 126 receives the user's response from the server plug-in manager 124. In this embodiment, many user responses are received simultaneously or near simultaneously.

In a step 440, the application plug-in 126 determines whether the number of negative responses meet a pre-determined threshold. If this threshold is reached, the II method 400 proceeds at step 440. If this threshold has not been reached, the method continues at step 415, as the user 112 continues watching the same performer.

In a step 444, the number of negative responses has met a pre-determined threshold. The performance is suspended and a different performer begins to perform. The method 400 continues at step 415 until such time that the user 112 decides to stop watching.

Alternative Embodiments

Although preferred embodiments are disclosed herein, many variations are possible which remain within the concept, scope and spirit of the invention; these variations would be clear to those skilled in the art after perusal of this application.

1. A method for managing user interactions with a media stream, including steps of
sending a streaming media presentation to at least one terminal;
receiving input from a user responsive to said streaming media presentation;
generating a content responsive to said input, wherein said content includes elements that were not included in said input;
encoding said content; and
streaming said content to at least one said terminal almost immediately after said input from a user was received.

2. A method in claim 1, wherein said presentation includes an is MPEG4 presentation.

3. A method as in claim 1, wherein said step of receiving input includes
determining an application associated with said input; and
determining an application plug-in associated with said application, wherein said application plug-in includes a set of instructions regarding at least one of the following: (1) analyzing said input, (2) generating a response to said input, (3) determining if additional steps are required to generate a response, (4) forwarding said input to another element wherein said additional steps are performed.

4. A method as in claim 1, wherein said step of generating a content includes automatically computing a set of responsive content.

5. A method as in claim 1, wherein said step of generating content includes identifying pre-prepared material

6. A method as in claim 1, wherein said step of sending a presentation includes multicasting said presentation to said terminals.

7. A method as in claim 1, wherein said step of sending a presentation includes unicasting said presentation to said terminal.

8. A method as in claim 1, wherein said step of streaming said content includes multicasting said presentation to said terminals.

9. A method as in claim 1, wherein said step of streaming said content includes unicasting said presentation to said terminal.

10. An apparatus for managing user interactions, including
a server for sending a media stream to a terminal, receiving input from said terminal in response to said media stream and sending content responsive to said input;
an application plug-in manager and at least one application plug-in coupled to said server, wherein said application plug-in manager determines an application associated with said input and identifies an application plug-in associated with said application;
a first software program for encoding said media stream and said content; and
an authoring module for generating said content in response to user input to a data stream, wherein said content is generated in real time and is responsive to at least one said input.

11. An apparatus as in claim 10, wherein said media stream includes an MPEG-4 presentation.

12. An apparatus as in claim 10, wherein said authoring module includes a memory and a set of instructions executable by a processor for generating content.

13. An apparatus as in claim 10, wherein said authoring module includes a memory including pre-prepared content and a set of instructions executable by a processor for identifying a portion of said pre-prepared content, said portion being responsive to said input.

14. An apparatus as in claim 10, wherein said terminal includes an element for receiving said media stream and presenting it to a user, sending said input from said user to said server and receiving said content from said server and presenting it to said user.

15. A memory, including a set of instructions executable by a processor said instructions including
sending a streaming media presentation to at least one terminal;
receiving input from a user responsive to said streaming media presentation;
generating a content responsive to said input;
encoding said content; and
streaming said content to at least one said terminal almost immediately after said input from a user was received.

16. A memory in claim 15, wherein said presentation includes an MPEG-4 presentation.

17. A memory as in claim 15, wherein said instruction of receiving input includes
determining an application associated with said input; and
determining an application plug-in associated with said application, wherein said application plug-in is included in a set of application plug-ins.

18. A memory, as in claim 15, wherein said instruction of generating content includes automatically computing a set of responsive content.

19. A memory as in claim 15, wherein said instruction of generating content includes identifying material in a content wherein said material is pre-prepared.

20. A memory as in claim 15, wherein said instruction of sending a presentation includes multicasting said presentation to at least two said terminals.

21. A memory as in claim 15, wherein said instruction of sending a presentation includes unicasting said presentation to at least one said terminal.

22. A memory as in claim 15, wherein said instruction of streaming said content includes multicasting said presentation to at least two said terminals.

23. A memory as in claim 15, wherein said instruction of streaming said content includes unicasting said presentation to at least one said terminal.
